(19) United States
(12) Patent Application Publication
(10) Pub. No.: US 2023/0036347 A1
(43) Pub. Date: Feb. 2, 2023

(54) FLEXIBLE ROBOT END EFFECTOR

(71) Applicant: SHENZHEN DORABOT INC., SHENZHEN (CN)

(72) Inventor: JIAN SHI, SHENZHEN (CN)

(21) Appl. No.: 17/738,026

(22) Filed: May 6, 2022

(30) Foreign Application Priority Data
Jul. 30, 2021 (CN) 202110870641.2

(51) Int. Cl. B25J 15/12; B25J 15/06; B25J 15/10

(52) U.S. Cl. CPC B25J 15/12; B25J 15/0616; B25J 15/10

(57) ABSTRACT

A flexible robot end effector includes the end effector including a mounting assembly and a flexible finger, one end of the flexible finger configured to mount at one side of the mounting assembly; the flexible finger including a protective layer and a plurality of holding mechanisms; the flexible finger further including a base, and two opposite sides of the base respectively connected with the holding mechanism and a pneumatic device; the protective layer configured to be sleeved on both outsides of the holding mechanism and the base so that an airtight chamber is formed among the base, the holding mechanism and the protective layer; when the air is blown into the airtight chamber by the pneumatic device, the flexible fingers inflated, and a gap between the two adjacent holding mechanisms gradually increasing.

### CROSS-REFERENCE TO RELATED APPLICATIONS

The present application claims priority to Chinese Patent entitled “A flexible end effector” of which Application No. is CN202110870641.2 filed to the Chinese Patent Office on Jul. 30, 2021, the disclosures which is incorporated herein by reference in its entirety.

### BACKGROUND OF THE INVENTION

The invention pertains to the field of logistics and sortation, and in particularly relates to a flexible robot end effector.

In the field of modern logistics, more and more application scenarios need to be automated due to the declining population and increasing labor costs. Among them, the application scenario that is the most urgent is the picking and handling technology of items, and vacuum gripper is a very important part to solve the automation problem of this scenario.

A vacuum gripper is an end effector used in industrial automation and robotics. It has the advantages of wide adaptability and its suction force for grasping objects can be controllable and so on, but it is easy to drop an item when the vacuum gripper absorbs items from the side of the item and it cannot flip the item. And moreover its stability is poor when the vacuum gripper moves at high speed.

At present, the end effectors widely used in the industry are mostly single-function grippers such as suction cups or parallel grippers. The gripper composed of flexible fingers only uses flexible materials. It is a new type of finger that is driven by pneumatic device, connecting rods, and pulling wires. It achieves better object shape adaptability through material and structural flexibility and under-actuated methods.

### SUMMARY OF THE INVENTION

The purpose of the invention is to provide a flexible robot end effector , aiming at solving the problem existing in the related art. The invention provides a type of end effector with strong clamping force and high flexibility, which can grasp heavy weight, large volume, and irregular shape items.

One aspect of the present disclosure is related to a flexible robot end effector, wherein the flexible robot end effector comprises: the end effector including a mounting assembly and a flexible finger, one end of the flexible finger configured to mount at one side of the mounting assembly; the flexible finger including a protective layer and a plurality of holding mechanisms; the holding mechanism providing with a first grasping portion and a second grasping portion which is connected with the first grasping portion, and further the maximum length of the first grasping portion is greater than that of the second grasping portion; the flexible finger further including a base, and two opposite sides of the base respectively connected with the holding mechanism and a pneumatic device; the protective layer configured to be sleeved on both outsides of the holding mechanism and the base so that an airtight chamber is formed among the base, the holding mechanism and the protective layer; when the air is blown into the airtight chamber by the pneumatic device, the flexible fingers inflated, and a gap between the two adjacent holding mechanisms gradually increasing; when the air is removed from the airtight chamber, the flexible fingers closed, and the gap between the two adjacent holding mechanisms gradually decreasing.

In accordance with one embodiment of the present disclosure, wherein the two adjacent holding mechanisms are directly connected by the first grasping portion.

In accordance with one embodiment of the present disclosure, wherein when two adjacent first grasping portions are on the same level of the horizontal direction, the gap between the two adjacent holding mechanisms is an inverted triangle.

In accordance with one embodiment of the present disclosure, wherein the flexible finger further includes a connecting portion, and two opposite ends of the connecting portion respectively connected with one first grasping portion.

In accordance with one embodiment of the present disclosure, wherein the connecting portion is made of fiberglass tape.

In accordance with one embodiment of the present disclosure, wherein the connecting portion is provided with a rotating shaft and a plurality of connected pieces, and two connected pieces are respectively arranged on two sides of the rotating shaft.

In accordance with one embodiment of the present disclosure, wherein the holding mechanism further includes a fixed plate which is provided with a fixed hole and a fixed shaft and connected with the first grasping portion, and the connected piece is inserted into the fixed hole through the fixed shaft so that the connecting portion is fixed on the fixed plate.

In accordance with one embodiment of the present disclosure, wherein the protective layer is made of LDPE material.

In accordance with one embodiment of the present disclosure, wherein the protective layer is provided with multiple layers for enhancing the wear resistance of the protective layer.

In accordance with one embodiment of the present disclosure, wherein the protective layer is made of nylon fabric, and the surface of the nylon fabric is coated by TPU.

In accordance with one embodiment of the present disclosure, wherein the holding mechanism is provided with a plurality of holes through which to allow the air to escape quickly from the holding mechanism to airtight chamber when the air is blown by the pneumatic device into the holding mechanism.

In accordance with one embodiment of the present disclosure, wherein the first grasping portion is configured to be trapezoidal while the second grasping portion is configured to be triangular, and further the second grasping portion is located on the short side of the first grasping portion.

In accordance with one embodiment of the present disclosure, wherein the first grasping portion is integrated with the second grasping portion into one piece, so that the holding mechanism is configured into a triangle.

In accordance with one embodiment of the present disclosure, wherein the fixed plate is made of plastic while the material of the first grasping portion and the second grasping portion is made of silica gel so that the part of end effector contacting with an object can be soft.

Another aspect of the present disclosure is related to a flexible robot end effector, comprising: the end effector including a mounting assembly, a suction cup and a flexible finger; the suction cup mounted on the mounting assembly, and at least two opposite sides of the mounting assembly are connected with the flexible finger; the flexible finger including a protective layer and a plurality of holding mechanisms, and the protective layer configured to be sleeved at the outer of the holding mechanisms; the holding mechanism providing with a first grasping portion and a second grasping portion which is connected with the first grasping portion, and further the maximum length of the first grasping portion is greater than that of the maximum length of the second grasping portion.

In accordance with one embodiment of the present disclosure, wherein the two adjacent holding mechanisms are directly connected through the first grasping portion.

In accordance with one embodiment of the present disclosure, wherein an included angle is formed between the two adjacent holding mechanisms, and the included angle is in the shape of an inverted triangle.

In accordance with one embodiment of the present disclosure, wherein the two adjacent first grasping portions are connected by a connecting portion.

In accordance with one embodiment of the present disclosure, wherein the connecting portion is made of fiberglass.

In accordance with one embodiment of the present disclosure, wherein the protective layer is made of LDPE material, and further the protective layer is provided with multiple layers for enhancing the wear resistance of the protective layer.

The beneficial effect of the embodiments is that it discloses a flexible robot end effector. The flexible robot end effector provides a mounting assembly to combine the suction cup with the flexible fingers together, so that the flexible fingers can cooperate with the suction cup to stably grasp the item and turn over the items, which improves the stability of the end effector and avoiding the items falling off the end effector in the process of accelerating or changing the speed of the end effector moving the items; and moreover the ability of the flexible robot end effector to adjust the pose of the item is increased, so that the grabbing efficiency and the handling cost rate of the end effector are greatly improved. In addition, because the flexible finger further includes a connecting portion, and two opposite ends of the connecting portion respectively connected with one first grasping portion, the length of the flexible end effector can be much longer to grab the heavier and bigger item, which solves the problem that the prior end effector can only grab the small the item.

### BRIEF DESCRIPTION OF THE DRAWINGS

The invention will be described with reference to the accompanying drawings. These and/or other aspects and advantages of the invention will become apparent and more readily appreciated from the following description of the embodiments, taken in conjunction with the accompanying drawings. Obviously, the drawings in the following description are only some embodiments of the embodiments of the invention, and it will be apparent to those skilled in the art that other drawings may be obtained in accordance with the structures illustrated in the drawings without departing from the scope of the invention.

FIG. 1 is a structure diagram of part of the flexible robot end effector according to an embodiment of the present application.

FIG. 2 is a structure diagram of FIG. 1 from another perspective.

FIG. 3 is a schematic structural diagram of a flexible finger being opened according to one embodiment of the present invention.

FIG. 4 is a schematic structural diagram of the flexible finger being closed.

FIG. 5 is a schematic structural diagram of a holding mechanism of the flexible end effector according to one embodiment of the present invention.

FIG. 6 is a schematic structural diagram of a holding mechanism of the flexible end effector according to another embodiment of the present invention.

FIG. 7 is a schematic structural diagram of a holding mechanism of the flexible end effector according to another embodiment of the present invention.

FIG. 8 is a schematic structural diagram of a holding mechanism and a connecting portion of the flexible end effector according to another embodiment of the present invention.

FIG. 9 is a schematic scenario diagram of a holding mechanism grasping a big item of the flexible end effector according to one embodiment of the present invention.

FIG. 10 is a schematic scenario diagram of a holding mechanism grasping a small item of the flexible end effector according to one embodiment of the present invention.

FIG. 11 is a schematic structural diagram of FIG. 10 from another perspective.

FIG. 12 is a structure diagram of the flexible robot end effector with the suction cup mounted on the mounting assembly according to an embodiment of the present application.

FIG. 13 is another schematic structural diagram of a flexible finger being opened according to one embodiment of the present invention.

### DETAILED DESCRIPTION OF THE INVENTION

The following is a clear and complete description of the technical solution in the invention in conjunction with the attached figure in the implementation of the invention. Obviously, the embodiments described are only a partial implementation of the present invention to help understand the present invention, and not the entire implementation. In addition, the technical features involved in the various embodiments of the present invention described below may be combined with each other as long as there is no conflict between them.

The terminology used in this application is for the purpose of describing particular embodiments only and is not intended to limit the application. As used in this application and the claims, the singular forms “a,” “the,” and “the” are intended to include the plural forms as well, unless the context clearly dictates otherwise. It will also be understood that the term “and/or” as used herein refers to and includes any and all possible combinations of one or more of the associated listed items.

It should be understood that although the terms “first”, “second”, “third”, etc. may be used in this application to describe various information, such information should not be limited to these terms. These terms are only used to distinguish the same type of information from each other. For example, the first information may also be referred to as the second information, and similarly, the second information may also be referred to as the first information without departing from the scope of the present application. Thus, a feature defined as “first” or “second” may expressly or implicitly include one or more of that feature. In the description of the present application, “plurality” means two or more, unless otherwise expressly and specifically defined.

The embodiment of the present application provides a flexible end effector, which aims to improve grabbing force and flexibility of the flexible fingers 3, which can grab objects of heavy weight, large volume, and irregular shape.

The technical solutions of the embodiments of the present application will be described in detail below with reference to the accompanying drawings.

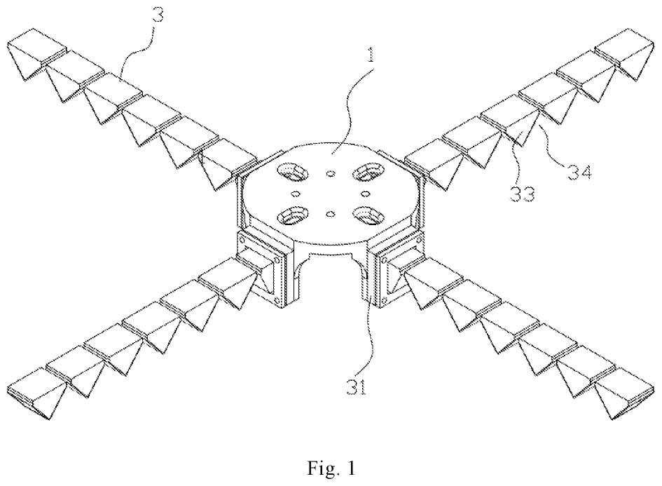

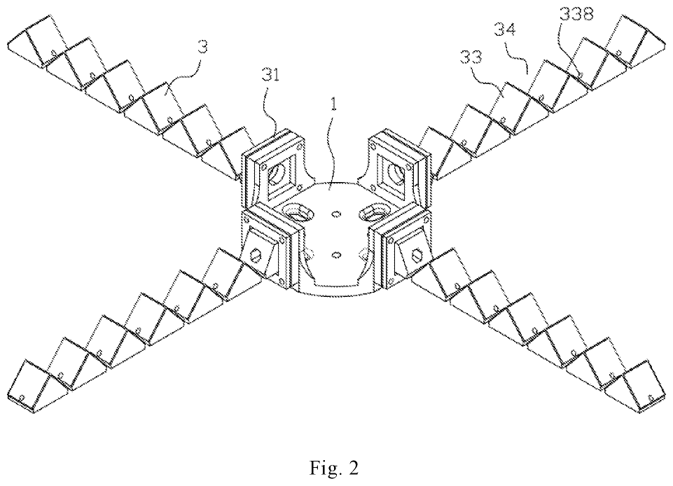

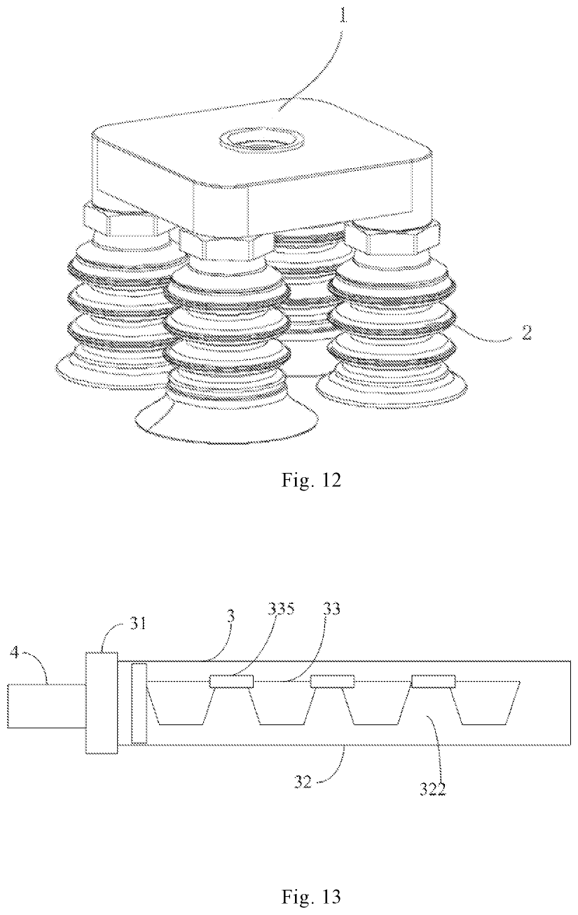

FIG. 1 is a structure diagram of part of the flexible robot end effector according to an embodiment of the present application; FIG. 2 is a structure diagram of FIG. 1 from another perspective; FIG. 12 is a structure diagram of the flexible robot end effector with the suction cup mounted on the mounting assembly according to an embodiment of the present application.

Referring to FIG. 1, FIG. 2 and FIG. 12, the embodiment of the invention is to provide a flexible robot end effector, the flexible robot end effector comprising a mounting assembly 1, a suction cup 2 and a flexible finger 3; the suction cup 2 mounted on the mounting assembly 1, and at least two opposite sides of the mounting assembly 1 are connected with the flexible finger 3. When the suction cup 2 adsorbs the item, the flexible fingers 3 is in a adaptive pose to cooperate with the suction cup 2 to stabilize the item or turn over the item.

Referring to FIG. 1, FIG. 2, FIG. 12 and FIG. 13, the embodiment of the invention is to provide a flexible robot end effector, the flexible robot end effector only includes a mounting assembly 1 and a flexible finger 3; and one end of the flexible finger is configured to mount at one side of the mounting assembly. In this embodiment of the invention, the end effector is without the suction cup, and when the end effector grabs the item, it only grabs the item with the flexible finger 3.

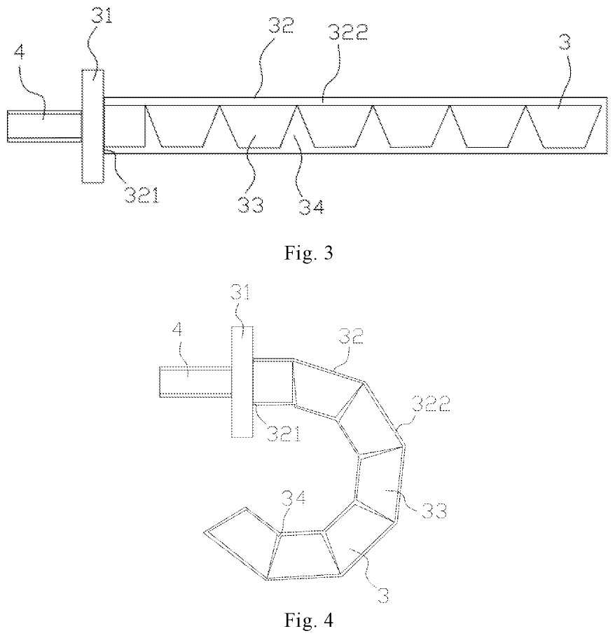

Referring to FIG. 1, FIG. 2, FIG. 3, FIG. 4, and FIG. 13, the flexible finger 3 includes a protective layer 32 and a plurality of holding mechanisms 33. The flexible finger 3 further includes a base 31, and two opposite sides of the base 31 are respectively connected with the holding mechanism 33 and a pneumatic device 4. The protective layer 32 is configured to be sleeved on both outsides of the holding mechanism 33 and the base 31 so that an airtight chamber 322 is formed among the base 31, the holding mechanism 33 and the protective layer 32. When the air is blown into the airtight chamber 322 by the pneumatic device 4, the flexible fingers 3 is inflated, and a gap between the two adjacent holding mechanisms 33 is gradually increasing. When the air is removed from the airtight chamber 322, the flexible fingers 3 is closed, and the gap between the two adjacent holding mechanisms 33 is gradually decreasing.

Referring to FIG. 1, FIG. 2, and FIG. 12, the flexible finger 3 is configured to connect with the mounting assembly 1 and is located at the peripheral side of the suction cup 2. For example, the mounting assembly 1 is in the shape of rectangular substantially, the suction cup 2 is mounted at one side of the mounting assembly 1 , and the flexible fingers 3 are mounted at the peripheral sides which are adjacent to the one side of the mounting assembly 1. Further, the flexible fingers 3 are mounted at two opposite peripheral sides of the mounting assembly 1 or the flexible fingers 3 are mounted at four peripheral sides of the mounting assembly 1. In one of the embodiment, the mounting assembly 1 is in the shape of cylindrical substantially, the suction cup 2 is located at the bottom of the cylindrical shape, and two flexible fingers 3 are mounted at two opposite peripheral sides of the cylindrical shape. Or one flexible finger 3 is mounted at one side of the two opposite peripheral sides while multiple flexible fingers 3 are mounted at the other of the two opposite peripheral sides and as a result, the the flexible fingers 3 can cooperate with the suction cup 2 to stably grasp the item and turn over the items when the suction cup 2 grasps the items. In one of the embodiment, the two opposite peripheral sides of the mounting assembly 1 are connected with multiple flexible fingers 3 respectively.

Referring to FIG. 1, FIG. 2, and FIG. 12, the flexible robot end effector includes at least one suction cup 2, for example, the number of suction cup 2 is one. Or the mounting assembly 1 is connected with three suction cups 2 which can cooperate with each other to grasp the items. Multiple suction cups 2 working at the same time can generate greater suction force for grasping the items, and the number of suction cups 2 should be determined according to the working scenarios, which is not limited in this application. A plurality of suction cups 2 can be operated or shut down at the same time, and the number of suction cups 2 can be reasonably designed according to the working scenario of the flexible robot end effector. Alternatively, each suction cup 2 is configured to be turned on or turned off individually to make a standard end effector, and in this way, the number of suction cups 2 which are turned on to grasp the items is suitable for the specifications of the item. In one embodiment, when grasping a small item, the suction cup 2 can be directly turned off, and the flexible fingers 3 are directly used to clamp the item to carry the item.

Referring to FIG. 1, FIG. 2, and FIG. 12, the flexible robot end effector provides a mounting assembly to combine the suction cup with the flexible fingers together, so that the flexible fingers can cooperate with the suction cup to stably grasp the item and turn over the items, which improves the stability of the end effector and avoiding the items falling off the end effector in the process of accelerating or changing the speed of the end effector moving the items; and moreover the ability of the flexible robot end effector to adjust the pose of the item is increased in which the end effector can only grasp one item at one time among a plurality of items, so that the grabbing efficiency and the handling cost rate of the end effector are greatly improved.

FIG. 3 is a schematic structural diagram of a flexible finger 3 being opened according to one embodiment of the present invention; FIG. 4 is a schematic structural diagram of the flexible finger 3 being closed.

Referring to FIG. 3, and FIG. 4, the flexible finger 3 includes a protective layer 32 and a plurality of holding mechanisms 33 and the adjacent holding mechanisms 33 are connected to each other. The protective layer 32 is configured to be sleeved on outsides of the holding mechanism 33 to protect the holding mechanism 33 and to drive the holding mechanism 33 to open or close. When the end effector grasps the item, the protective layer 32 drives the holding mechanisms 33 to close, resulting in deformation, and multiple holding mechanisms 33 approach each other and bend to clamp the item; when the end effector puts down the item, the protective layer 32 drives the holding mechanisms 33 to open, and the multiple holding mechanisms 33 are separated from each other and straightened in order to release the item.

Referring to FIG. 3, and FIG. 4, in one embodiment, the protective layer 32 is made of LDPE material which has advantages of good toughness, high wear resistance, and good sealing performance to easily to control the pressure inside the protective layer 32. More specific, the protective layer 32 is provided with multiple layers for enhancing the wear resistance of the protective layer 32. Alternatively, the protective layer is made of nylon fabric and the surface of the nylon fabric is coated by TPU.

Referring to FIG. 3, and FIG. 4, the flexible finger 3 is connected to the pneumatic device 4 which is connected with the protective layer 32, and the pneumatic device 4 controls the inflation and deflation of the protective layer 32 to control the open and close of the holding mechanism 33. The flexible finger 3 further comprises a base 31 whose one end is connected with the pneumatic device 4 and the other end is connected with the holding mechanism 33.

Referring to FIG. 3, and FIG. 4, the protective layer 32 further includes a fixed portion 321 connected with the base 31 in order to form the airtight chamber 322 between the interior of the protective layer 32 and the base 31.

Referring to FIG. 1, FIG. 2, FIG. 3, and FIG. 4, the holding mechanism 33 is provided with a plurality of holes 338 through which to allow the air to escape quickly from the holding mechanism 33 to airtight chamber 322 when the air is blown by the pneumatic device 4 into the holding mechanism 33.

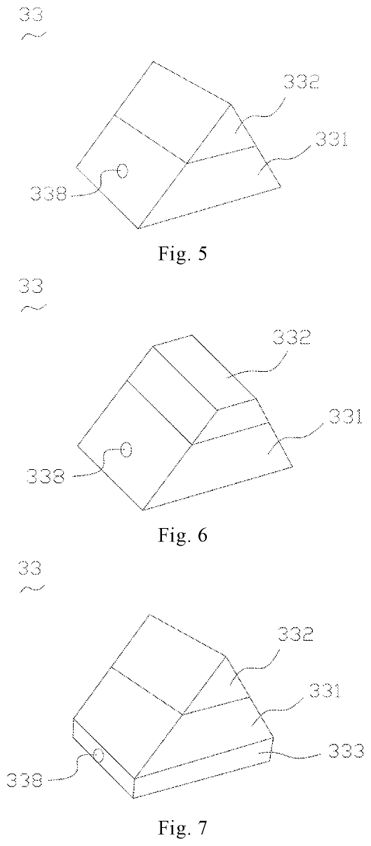

FIG. 5 is a schematic structural diagram of a holding mechanism 33 of the flexible end effector according to one embodiment of the present invention.

Referring to FIG. 5, the holding mechanism 33 provides with a first grasping portion 331 and a second grasping portion 332 which is connected with the first grasping portion 331. Referring to FIG. 1, FIG. 2 and FIG. 5, specifically, the vertical cross-section of the first grasping portion 331 is trapezoidal while the vertical cross-section of the second grasping portion 332 is triangular. In addition the second grasping portion 332 is located on the short side of the first grasping portion 331, and further the maximum length of the first grasping portion 331 is greater than that of the second grasping portion 332, which facilitates the formation of bending of the flexible finger 3 to hold the item firmly when the plurality of first grasping portions 331 and the plurality of second grasping portions 332 are clamped tightly to each other. The first grasping portion 331 and the second grasping portion 332 are made of different materials, and more specific, the first grasping portion 331 is made of plastic while the second grasping portion 332 is made of silica gel so that the part of end effector contacting with an object can be soft. In another word, the hardness of the first grasping portion 331 is greater than that of the second grasping portion 332.

Referring to FIG. 1, FIG. 2 and FIG. 5, in some embodiments, the two adjacent holding mechanisms 33 are directly connected by the first grasping portion 331. The flexible finger 3 is provided with at least two holding mechanisms 33, and the plurality of holding mechanisms 33 are connected to each other through the first grasping portions 331, and the number of the holding mechanisms 33 can be set according to the need of the scenario so that length of flexible fingers 3 can be unlimited.

Referring to FIG. 1, FIG. 2, FIG. 5 and FIG. 13, in one embodiment, the flexible finger 3 further includes a connecting portion 335, and two opposite ends of the connecting portion 335 respectively connected with one first grasping portion 331.

Referring to FIG. 1, FIG. 2, FIG. 3 and FIG. 4, in one embodiment, when two adjacent first grasping portions 331 are on the same level of the horizontal direction, the gap 34 between the two adjacent holding mechanisms 33 is an inverted triangle. In another word, an included angle 34 is formed between two adjacent holding mechanisms 33, and moreover the included angle 34 is an inverted triangle. During the closing process of the holding mechanism 33, the first grasping portion 331 and the adjacent first grasping portion 331 are moved toward to each other, and at the some time the second grasping portion 332 and the adjacent second grasping portion 332 are also moved toward to each other. An angle 34 is formed between two adjacent holding mechanisms 33, and since the included angle 34 is an inverted triangle, the holding mechanism 33 can be closed to form a curved shape, and then the flexible fingers 3 can grasp the items firmly. More specific, after the holding mechanism 33 is clamped, the two adjacent holding mechanisms 33 are closely matched, and the included angle 34 becomes smaller and smaller.

Referring to FIG. 3 and FIG. 4, During the operation of the end effector: when the pneumatic device 4 inflates the holding mechanism 33, the first grasping portion 331 of the holding mechanism 33 moves outward, and the second grasping portion 332 moves in the direction of the first grasping portion 331, and then the end effector is open. In another word, when the air is blown into the airtight chamber 322 by the pneumatic device 4, the flexible fingers 3 are inflated, and the gap between the two adjacent holding mechanisms 33 is gradually increasing, so when the two adjacent first grasping portions 331 are on the same level of the horizontal direction, the gap between the two adjacent holding mechanisms 33 is in the shape of an inverted triangle. Because of the airtight chamber 322, the pressure times the volume is always constant in a constant temperature sealed gas chamber. When the pneumatic device 4 inflates the holding mechanism 33, the volume of the airtight chamber 322 gradually increases so the the end effector is moving outward. And then the pressure within the airtight chamber 322 is greater than that of outer of the airtight chamber 322. When the air is removed from the airtight chamber 322, the pressure within the airtight chamber 322 is less than that of outer of the airtight chamber 322. In another word, the pressure of the outer of the protective layer 32 is greater than that within the protective layer 32 which means that the air outside the protective layer 32 will exert a force that compresses the airtight chamber 322 within the protective layer 32 to equalize the pressure in the airtight chamber 322, thereby causing the end effector to bend inward. And then the first grasping portion 331 moves toward the second grasping portion 332, and the adjacent holding mechanisms 33 approach toward each other, so that the end effector can tightly grasp the items when closed.

FIG. 6 is a schematic structural diagram of a holding mechanism 33 of the flexible end effector according to another embodiment of the present invention.

Referring to FIG. 6, the vertical cross-section of the first grasping portion 331 is in the shape of a trapezoid and the vertical cross-section of the second grasping portion 332 is also in the shape of a trapezoid.

FIG. 7 is a schematic structural diagram of a holding mechanism 33 of the flexible end effector according to another embodiment of the present invention.

Referring to FIG. 7, the holding mechanism 33 further includes a fixed plate 333 which is made of plastic and the first grasping portion 331 is arranged on the fixed plate 333. The first grasping portion 331 and the second grasping portion 332 are made of silica gel so that the part of end effector contacting with an object is soft to protect the items in process of the end effector grasping the them. In some embodiments, the first grasping portion 331 is configured to be trapezoidal while the second grasping portion 332 is configured to be triangular or arc-shaped or other shapes, and further the second grasping portion 332 is located on the short side of the first grasping portion 331.

In one embodiment, the width of one side that is close to the base 31 of the fixed plate 333 is greater than the width of the other side that is away from the base 31 of the fixed plate 333, that is, the width of the fixed plate 333 gradually decreases from left to right, so that the torque of the holding mechanism 33 close to the base 31 is maximized, thereby improving the grasping force of the flexible fingers.

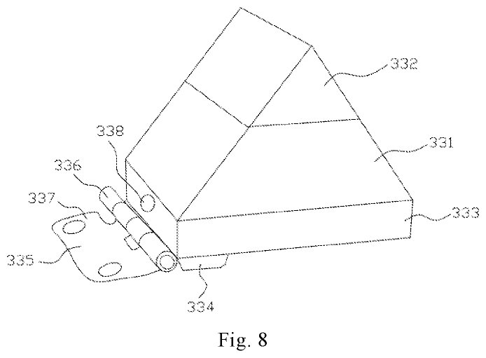

FIG. 8 is a schematic structural diagram of a holding mechanism 33 and a connecting portion 335 of the flexible end effector according to another embodiment of the present invention.

Referring to FIG. 8, the flexible finger further includes a connecting portion 335, and two opposite ends of the connecting portion 335 respectively connected with one first grasping portion 331.

In one embodiment, the connecting portion 335 is made of fiberglass tape which has high tensile strength and good wear resistance in order for the flexible finger to bend.

Referring to FIG. 7 and FIG. 8, in some embodiment, the holding mechanism 33 further includes a fixed plate 333 which is made of plastic. And the first grasping portion 331 is configured to arrange on the fixed plate 333. Moreover, the first grasping portion 331 and the second grasping portion 332 are made of silica gel so that the part of end effector contacting with an object is soft to protect the items in process of the end effector grasping the them. In some embodiments, the first grasping portion 331 is configured to be trapezoidal while the second grasping portion 332 is configured to be triangular or arc-shaped or other shapes, and further the second grasping portion 332 is located on the short side of the first grasping portion 331.

Referring to FIG. 7 and FIG. 8, the two adjacent holding mechanisms 33 are connected by the connecting portion 335 which is made of metal material and the connecting portion 335 is provided with a rotating shaft 336 and a plurality of connected pieces 337 and two connected pieces 337 are respectively arranged on two sides of the rotating shaft 336. Moreover, and the fixed plate 333 is provided with a fixed hole and a fixed shaft 334 and the connected piece 337 is inserted into the fixed hole through the fixed shaft 334 so that the connecting portion 335 is fixed on the fixed plate 333 and further as a result, the two adjacent holding mechanisms 33 are connected through the connecting portion 335.

In some embodiment, the connected piece 337 is arranged beneath the fixed plate 333, that is, the fixed hole (not shown) is located on the bottom surface of the fixed plate 333.

In some embodiment, the fixed plate 333 is provided with a plurality of holes 338 through which to allow the air to escape quickly from the holding mechanism 33 to airtight chamber 322 when the air is blown by the pneumatic device 4 into the holding mechanism 33.

In order to facilitate the subsequent description of the process in which the flexible fingers 3 cooperate with the suction cup 2 to stabilize or turnover an item 5, the item 5 is defined as follows: the item 5 has a top surface 51, a bottom surface 56, a side surface 52, and another side surface 54 opposite to the side surface 52. And the item 5 also has a side 53 and a side 55 which are connected with the side surface 52 and the side surface 54 respectively and moreover the side 53 is opposite to the side 55. In addition, the side 53 and the side 55 can also be the same side, such as a cylindrical surface. And the flexible fingers 33 arranged in different positions are named as flexible fingers 33a, flexible fingers 33b, and so on.

In a scenario where the end effector is carrying an item, the suction cup 2 adsorbs the side surface of the item, the flexible finger 3 is located on the peripheral side of the suction cup 2, the flexible finger 3 is located on the peripheral side of the item and is in contact with the item, and the flexible finger 3 is bent to exert a force to the item so that the flexible finger 3 can stabilize the pose of the item in the process of moving the item, and so that the end effector can move the item at a faster speed.

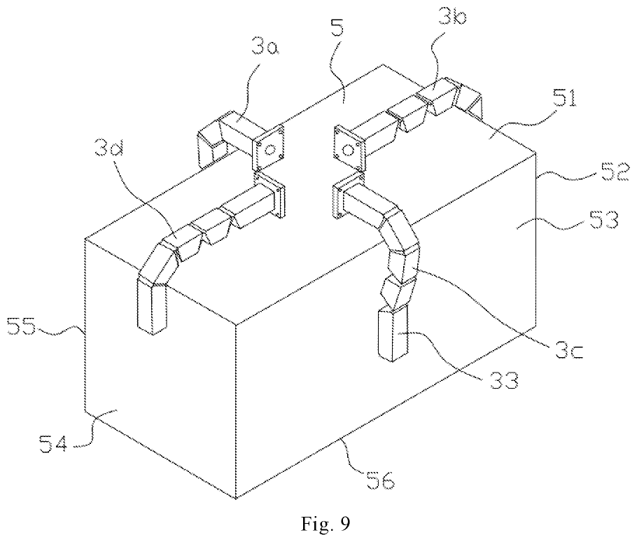

FIG. 9 is a schematic scenario diagram of a holding mechanism 33 grasping a big item of the flexible end effector according to another embodiment of the present invention.

Referring to FIG. 9, in a scenario where the end effector is carrying large items, the flexible fingers 3 of the end effector are inflated and opened to grasp only one item among multiple items.

After picking up the item, the suction cup 2 of the end effector absorbs the top surface 51 of the item and the flexible fingers 3 deflate, thereby the plurality of holding mechanisms 33 approach together and deform, and as a result the flexible fingers 3 firmly grasp the sides of the item. Specific, the end effector is provided with four flexible fingers 3 which are flexible fingers 33a, flexible fingers 33b, flexible fingers 33c and flexible fingers 33d which grasps the side surface 55, the side surfaces 52, 53, 54 respectively so that the end effector can firmly hold the big item and avoid the situation that the item would rotate because of the gravity or pull. On one hand, the top surface 51 of the item 5 can be sucked by the suction cup 2, and on the other hand, the flexible fingers 3 can directly grasp the side surface of the article firmly without the suction cup 2 absorbing the top surface of the item.

The flexible finger 3 is inflated and deflated by the pneumatic device 4 which facilitates the deformation of the flexible finger 3, thereby accomplishing the placing and clamping of the item.

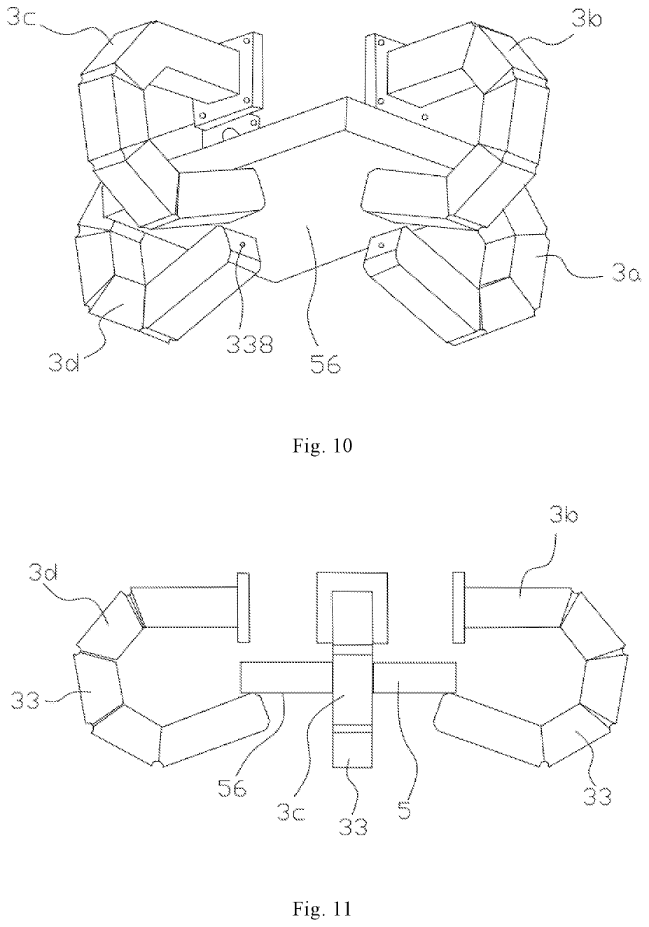

FIG. 10 is a schematic scenario diagram of a holding mechanism 33 grasping a small item of the flexible end effector according to another embodiment of the present invention. FIG. 11 is a schematic structural diagram of FIG. 10 from another perspective.

Referring to FIG. 10 and FIG. 11, in a scenario where the end effector is carrying small items, the flexible fingers 3 of the end effector are inflated and opened to grasp only one item among multiple items.

After picking up the item, the suction cup 2 of the end effector absorbs the top surface 51 of the item and the flexible fingers 3 deflate, thereby the plurality of holding mechanisms 33 approach together and deform, and as a result the flexible fingers 3 firmly grasp the sides of the item. Specific, the end effector is provided with four flexible fingers 3 which are flexible fingers 33a, flexible fingers 33b, flexible fingers 33c and flexible fingers 33d which grasps the side surface 55, the side surfaces 52, 53, 54 respectively so that the end effector can firmly hold the big item and avoid the situation that the item would rotate because of the gravity or pull. On one hand, the top surface 51 of the item 5 can be sucked by the suction cup 2, and on the other hand, the flexible fingers 3 can directly grasp the side surface of the article firmly without the suction cup 2 absorbing the top surface of the item.

The flexible robot end effector provides a mounting assembly 1 to combine the suction cup 2 with the flexible fingers 3 together, so that the flexible fingers 3 can cooperate with the suction cup 2 to stably grasp the item and turn over the items, which improves the stability of the end effector and avoiding the items falling off the end effector in the process of accelerating or changing the speed of the end effector moving the items; and moreover the ability of the flexible robot end effector to adjust the pose of the item is increased, so that the grabbing efficiency and the handling cost rate of the end effector are greatly improved.

The embodiments of the present invention are described in detail above in conjunction with the drawings, but the present invention is not limited to the described embodiments. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A flexible robot end effector, comprising:
the end effector including a mounting assembly and a flexible finger, one end of the flexible finger configured to mount at one side of the mounting assembly;
the flexible finger including a protective layer and a plurality of holding mechanisms;
the holding mechanism providing with a first grasping portion and a second grasping portion which is connected with the first grasping portion, and further the maximum length of the first grasping portion is greater than that of the second grasping portion;
the flexible finger further including a base, and two opposite sides of the base respectively connected with the holding mechanism and a pneumatic device;
the protective layer configured to be sleeved on both outsides of the holding mechanism and the base so that an airtight chamber is formed among the base, the holding mechanism and the protective layer;
when the air is blown into the airtight chamber by the pneumatic device, the flexible fingers inflated, and a gap between the two adjacent holding mechanisms gradually increasing;
when the air is removed from the airtight chamber, the flexible fingers closed, and the gap between the two adjacent holding mechanisms gradually decreasing.

2. The flexible robot end effector as defined in claim 1, wherein the two adjacent holding mechanisms are directly connected by the first grasping portion.

3. The flexible robot end effector as defined in claim 1, wherein when two adjacent first grasping portions are on the same level of the horizontal direction, the gap between the two adjacent holding mechanisms is an inverted triangle.

4. The flexible robot end effector as defined in claim 1, wherein the flexible finger further includes a connecting portion, and two opposite ends of the connecting portion respectively connected with one first grasping portion.

5. The flexible robot end effector as defined in claim 4, wherein the connecting portion is made of fiberglass tape.

6. The flexible robot end effector as defined in claim 4, wherein the connecting portion is provided with a rotating shaft and a plurality of connected pieces, and two connected pieces are respectively arranged on two sides of the rotating shaft.

7. The flexible robot end effector as defined in claim 6, wherein the holding mechanism further includes a fixed plate which is provided with a fixed hole and a fixed shaft and connected with the first grasping portion, and the connected piece is inserted into the fixed hole through the fixed shaft so that the connecting portion is fixed on the fixed plate .

8. The flexible robot end effector as defined in claim 1, wherein the protective layer is made of LDPE material.

9. The flexible robot end effector as defined in claim 1, wherein the protective layer is provided with multiple layers for enhancing the wear resistance of the protective layer.

10. The flexible robot end effector as defined in claim 1, wherein the protective layer is made of nylon fabric, and the surface of the nylon fabric is coated by TPU.

11. The flexible robot end effector as defined in claim 1, wherein the holding mechanism is provided with a plurality of holes through which to allow the air to escape quickly from the holding mechanism to airtight chamber when the air is blown by the pneumatic device into the holding mechanism.

12. The flexible robot end effector as defined in claim 1, wherein the first grasping portion is configured to be trapezoidal while the second grasping portion is configured to be triangular, and further the second grasping portion is located on the short side of the first grasping portion.

13. The flexible robot end effector as defined in claim 12, wherein the first grasping portion is integrated with the second grasping portion into one piece, so that the holding mechanism is configured into a triangle.

14. The flexible robot end effector as defined in claim 7, wherein the fixed plate is made of plastic while the material of the first grasping portion and the second grasping portion is made of silica gel so that the part of end effector contacting with an object can be soft.

15. A flexible robot end effector, comprising:
the end effector including a mounting assembly, a suction cup and a flexible finger;
the suction cup mounted on the mounting assembly, and at least two opposite sides of the mounting assembly are connected with the flexible finger;
the flexible finger including a protective layer and a plurality of holding mechanisms, and the protective layer configured to be sleeved at the outer of the holding mechanisms;
the holding mechanism providing with a first grasping portion and a second grasping portion which is connected with the first grasping portion, and further the maximum length of the first grasping portion is greater than that of the maximum length of the second grasping portion.

16. The flexible robot end effector as defined in claim 15, wherein the two adjacent holding mechanisms are directly connected through the first grasping portion.

17. The flexible robot end effector as defined in claim 16, wherein an included angle is formed between the two adjacent holding mechanisms, and the included angle is in the shape of an inverted triangle.

18. The flexible robot end effector as defined in claim 15, wherein the two adjacent first grasping portions are connected by a connecting portion.

19. The flexible robot end effector as defined in claim 18, wherein the connecting portion is made of fiberglass.

20. The flexible robot end effector as defined in claim 15, wherein the protective layer is made of LDPE material, and further the protective layer is provided with multiple layers for enhancing the wear resistance of the protective layer.
